(19) United States
(12) Patent Application Publication
(10) Pub. No.: US 2005/0015406 A1
(43) Pub. Date: Jan. 20, 2005

(54) Method and system for customizable client aware content selection and rendering in a portal server

(76) Inventors: Mihir Y. Sambhus, Milpitas, CA (US); Sathyanarayanan N. Kavacheri, Sunyvale, CA (US); Gregory J. Ziebold, Superior, CO (US); Luu D. Tran, Santa Clara, CA (US)

Correspondence Address: OSHA & MAY L.L.P./SUN, 1221 MCKINNEY, SUITE 2800, HOUSTON, TX, 77010, US

(21) Appl. No.: 10/622,035

(22) Filed: Jul. 16, 2003

(51) Int. Cl. G06F 17/30

(52) U.S. Cl. 707/200

(57) ABSTRACT

A method and system for customizable client aware content aggregation and rendering in a portal server. The method includes step of servicing a request for content using at least one of a plurality of channels. To service the request, a first file path is accessed. The first file path points to generic non-customized information for a client device. A second of file path is accessed to service the request, wherein the second file path points to customized information, and wherein the second file path is accessed subsequent to the first file path. Aggregated content from a plurality channels is processed using a rendering engine, wherein the rendering engine is configured to output the aggregated content in a markup language tailored for the client device. The aggregated content is subsequently output in the second markup language to the client device.

This application is related to commonly assigned copending U.S. Patent Application “A METHOD AND SYSTEM FOR CLIENT AWARE CONTENT AGGREGATION AND RENDERING IN A PORTAL SERVER” by Sambhus et al., filed on ______, Ser. No. ______, Attorney Docket No. SUN-P030086, and “A METHOD AND SYSTEM FOR RESPONSE BUFFERING IN A PORTAL SERVER FOR CLIENT DEVICES” by Batchu et al., filed on ______, Ser. No. ______, Attorney Docket No. SUN-P030062, which are both incorporated herein in their entirety.

### TECHNICAL FIELD

The present invention relates generally to portal servers and, in particular, to wireless portal servers having customizable client aware content selection and rendering capability.

### BACKGROUND ART

The use of Web portals has become widespread for obtaining information, news, entertainment, and the like, via the World Wide Web. A Web portal is generally a Web “supersite” that provides a variety of services including Web searching, news, white and yellow pages directories, free e-mail, discussion groups, online shopping and links to other sites. The Web portal term is generally used to refer to general purpose sites, however, it is increasingly being used to refer to vertical market sites that offer the same services, but only to a particular industry such as banking, insurance or computers, or fulfill specific needs for certain types of users, for example, business travelers who are often away from their office or their primary point of business.

Certain types of Web portals have evolved into customized, user type specific sources of information. One example would be a corporate Web site, wherein an internal Web site (intranet) provides proprietary, enterprise-wide information to company employees as well as access to selected public Web sites and vertical-market Web sites (suppliers, vendors, etc.). Such a Web site would typically include a customized search engine for internal documents as well as the ability to customize the portal page for different user groups and individuals. Access to such customized Web sites by business travelers, or other types of users who require concise prompt access to information, is a highly sought-after goal. For example, for a mobile user (e.g., business traveler), it would be very advantageous to obtain wireless access to a Web portal via a portable handheld device, such as a cell phone or a wireless PDA. However, presentation of information on the small screens typical with such portable handheld devices requires customization of the Web portal and the formatting of the data it provides.

Standards have been developed to provide a widely used method of formatting data for the smaller screens of portable handheld devices. One such standard is WML (Wireless Markup Language). WML is a tag-based language used in the Wireless Application Protocol (WAP). WML is an XML document type allowing standard XML and HTML tools to be used to develop WML applications. WAP is a standard for providing cellular phones, pagers and other handheld devices with secure access to e-mail and text-based Web pages. WAP provides a complete environment for wireless applications that includes a wireless counterpart of TCP/IP and a framework for telephony integration such as call control and phone book access. WAP features the Wireless Markup Language (WML) and is a streamlined version of HTML for small screen displays. It also uses WMLScript, a compact JavaScript-like language that runs in limited memory. WAP is designed to run over all the major wireless networks in place now and in the future.

A conventional portal server arrangement is shown in FIG. 1A and is indicated by the general reference character 100. This high-level representation of portal server operation includes Access Device 102, Portal Server 104, Identity Server 106, and Application/Web Server 108. In standard operation, a user logs into Identity Server 106 by giving a suitable user name and password. Once the user has been authenticated, a request made from Access Device 102 can be forwarded to Portal Server 104 and content supplied by Application/Web Server 108 can be sent to the Access Device as a Front Page. A given front page may display several different channels of content. An example of channels as arranged in a front page or personalized web page display is indicated by the general reference character 120 shown in FIG. 1B. One channel may include Mail 122 while another may include a calendar function, for example. Back-end standard server 124 may be any type of mail server, such as “Exchange,” that can be used to convey mail content. FIG. 1C shows an example of a channel 140 with the title “Mail” that may be part of a front page requested by a user. The display or “markup” may contain a minimize button 142 and/or a close button 144. The content 146 can be generated by a provider and may include such items as the number of total messages and the number of unread messages, for example. A container may include information from a number of such content providers for a variety of channels.

As the number of different types of access devices proliferates, conventional portal servers are not equipped to provide the appropriate markup for each type of device. Each cellular phone or personal digital assistant (PDA) device understands a different type of markup language. For example, a PDA may have a completely different display than a mobile phone. Examples of types of markup language include HyperText Markup Language (HTML) commonly used for PC-based applications, Wireless Markup Language (WML) for mobile applications, Compact HTML (CHTML) for small information appliances, and Extensible HTML (XHTML) as an HTML alternative language.

The default path is to use a PC-based HTML type of markup, but this does not work on many non-PC access devices. In a mobile phone type of access device, for example, there is not a standard or universal type of markup language. There are several different types of markup language with each phone manufacturer and/or service provider using its own markup for a particular “look-and-feel” of the device. In conventional portal server approaches, it is very difficult and not cost effective to handle the thousands of different access devices currently available. One solution to this problem, as will be described in more detail below, involves using a generic markup language, such as Abstract Markup Language (AML), and then converting a document from AML to a device-specific markup language. A limitation of this approach is in the level of customization of the device-specific markup language that is generated per device. Moreover, a given device-specific markup language may not be ideal for certain Access Device.

It would be desirable to have a way to customize the containers and providers so that the markup can be customized while being generated dynamically in a wireless portal server. Although tools are in place (e.g., wirelessly connected portable handheld devices, WML and WAP based communications standards, customized Web portals, etc.) to provide customized, application specific, information to business travelers and other various types of users via portable handheld devices, existing prior art applications and methods are still generally targeted towards desktop implementations. The number of individually customized and tailored information delivery mechanisms is limited.

### DISCLOSURE OF THE INVENTION

The present invention provides a solution that can customize information presented from a Web site or a Web portal with respect to a particular device of an individual user. The present invention automatically formats the information in accordance with the requirements of a particular client device.

In one embodiment, the present invention is implemented as a method for customizable client aware content aggregation and rendering in a portal server. The method includes step of servicing a request for content using at least one of a plurality of channels. To service the request, a first file path is accessed. The first file path points to generic non-customized information for a client device. A second file path is accessed to service the request, wherein the second file path points to customized information for the client device. The first file path can be the default file path. Aggregated content from a plurality channels is processed using a rendering engine, wherein the rendering engine is configured to output the aggregated content in a markup language tailored for the client device. The aggregated content is subsequently output in the second markup language to the client device.

In another embodiment, the present invention is implemented as a method of customizing markup includes two options: (i) changing a file path so as to not select a default Abstract Markup Language (AML) file path; and/or (ii) introducing special “tags” around device-specific markup. In this way, an AML page or document can be changed to customize the generated markup. This “customized” AML can be used to change the “look-and-feel” of a particular device accessing a portal server.

### BRIEF DESCRIPTION OF THE DRAWINGS

The accompanying drawings, which are incorporated in and form a part of this specification, illustrate embodiments of the invention and, together with the description, serve to explain the principles of the invention:

Prior art FIG. 1A is a diagram of a conventional portal server in relation to an accessing device.

Prior art FIG. 1B is a diagram of a conventional front page presented on an access device.

Prior art FIG. 1C is a diagram of a conventional channel with content from a provider.

FIG. 2 is a block diagram of a portal server interface structure in accordance with one embodiment of the present invention.

FIG. 3 is a block diagram of an example rendering container provider having customizable markup capability for all rendering type channels in accordance with one embodiment of the present invention.

FIG. 4 is a block diagram of an example rendering container provider having customizable markup capability for two rendering type channels and one non-rendering type channel in accordance with one embodiment of the present invention.

FIG. 5 is a block diagram of an example WML container provider having customizable markup capability for two non-rendering type channels and one rendering type channel in accordance with one embodiment of the present invention.

FIG. 6 is a flow diagram of a method of processing a request for content with customizable markup capability in accordance with one embodiment of the present invention.

FIG. 7 is a flow diagram of a method of performing customization of markup in accordance with one embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Notation and nomenclature

Some portions of the detailed descriptions which follow are presented in terms of procedures, steps, logic blocks, processing, and other symbolic representations of operations on data bits within a computer memory. These descriptions and representations are the means used by those skilled in the data processing arts to convey most effectively the substance of their work to others skilled in the art. A procedure, computer executed step, logic block, process, etc., are here, and generally, conceived to be self-consistent sequences of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing,” “examining,” “accessing,” “routing,” “determining,” “transmitting,” -storing,” or the like, refer to the action and processes of a computer system, or similar electronic computing device, that manipulates and transforms data represented as physical (electronic) quantities within the computer system's registers and memories into other data similarly represented as physical quantities within the computer system registers or memories or other such information storage, transmission, or display devices Embodiments of the present invention function in part to solve problems associated with handling content requests from one of a large number of possible devices. Embodiments the present invention provide a way to transfer the content information from a web or application server by using a generic or Abstract Markup Language (AML) and a “Rendering Container”. Using AML and converting to an appropriate device-specific language using a “Rendering Engine” allows a portal server to accommodate conceivable access devices. Embodiments of the present invention utilize abstract markup language but still efficiently enable the customization of the content provided to the client devices. Implementations of this approach can include software that can be installed on a server, such as a portal server.

In solving problems associated with handling content requests from one of a large number of possible devices, a way to transfer the content information from a web or application server by using a generic or Abstract Markup Language (AML) and a “Rendering Container” can be employed. Using AML and converting to an appropriate device-specific language using a “Rendering Engine” allows a portal server to accommodate conceivable access devices. Further, according to embodiments, methods of customizing markup include: (i) changing a file path so as to not select the default AML file path; and/or (ii) introducing special “tags” around device-specific markup. In this way, an AML page or document can be changed to customize the generated markup. This “customized” AML can be used to change the “look-and-feel” of a particular device. For example, customization can be used by a cellular phone service carrier in order to create a standard drop-down menu look-and-feel across different mobile phone models. Implementations of this approach can include software that can be installed on a server, such as a portal server.

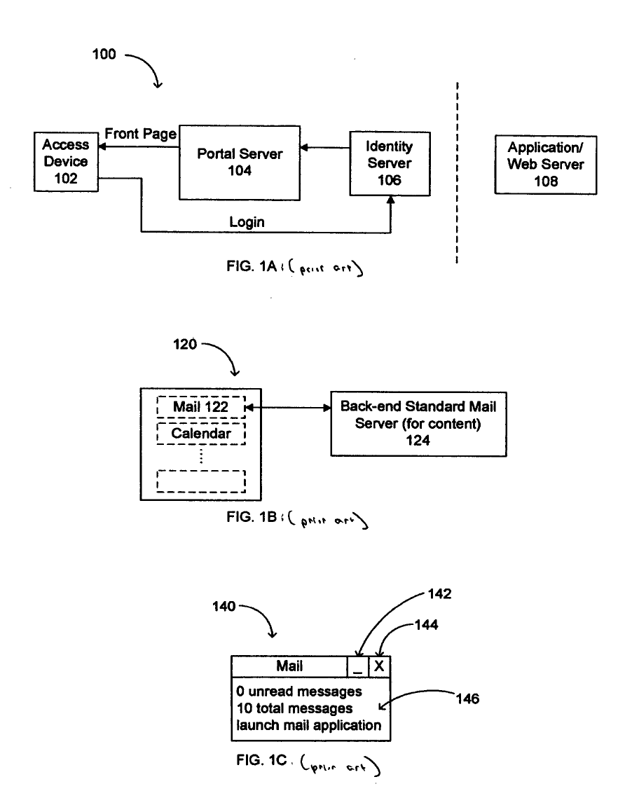

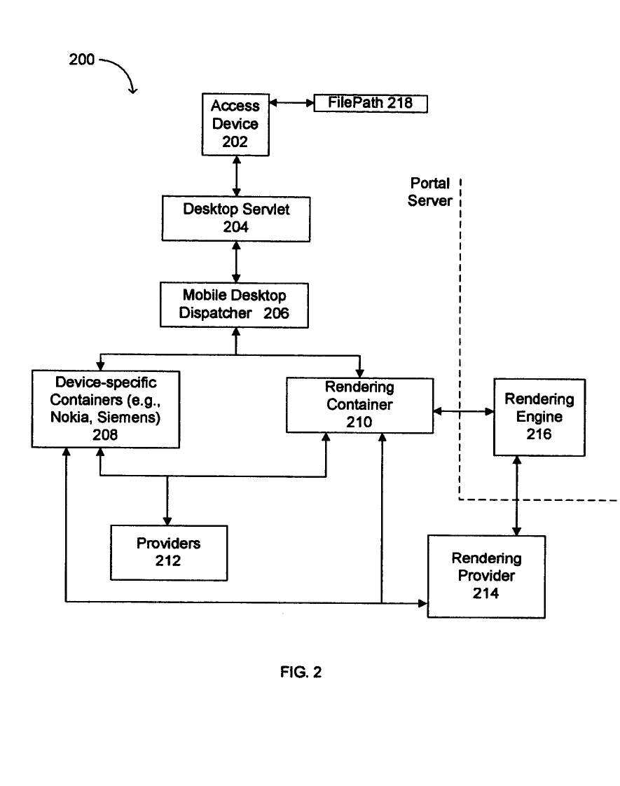

Referring now to FIG. 2, a block diagram of a portal server interface structure according to an embodiment is shown and indicated by the general reference character 200. Access Device 202 can interface to Desktop Servlet 204. The Access Device can be a mobile phone, a PDA, or any appropriate computing device. Each Access Device needing rendering can have an associated FilePath 218 that can be stored in an Identity Server, for example. The Desktop Servlet can present the front page, which can contain an assortment of channels of content and the like, to the Access Device. Desktop Servlet 204 can interface to Mobile Desktop Dispatcher 206. Based on the type of Access Device and the configuration of the portal, a request from the Access Device can be sent to Device-specific Containers 208 and/or Rendering Container 210. There can be a number of Device-specific Containers representing instances for different types of devices, such as Nokia or Siemens type mobile phone devices. Rendering Container 210 can include AML templates from the content providers. The containers can act to aggregate and present the content in a format suitable for a particular application or Access Device type. This can include customization of the generic AML for a particular Access Device. Rendering Container 210 can aggregate content from Providers 212 and/or Rendering Provider 214. Rendering Container 210 can also interface to Rendering Engine 216. The Rendering Engine can receive a document in AML format and translate the document into a device-specific markup language. Providers 212 can be “native” Providers that can interface to the Device-specific Containers 208 and/or Rendering Container 210. Non-rendering Providers can be designated for Access Devices supported by the Portal Server and can generate device-specific markup language instead of a generic language, such as AML. Rendering Provider 214 can interface to Device-specific Containers 208 and/or Rendering Container 210. The Rendering Provider can provide content in AML format.

According to an embodiment, in one mode of operation, a request can arrive via the Access Device from an authenticated user to the Desktop Servlet. The Desktop Servlet can begin to form the front page, but the proper format suitable for the Access Device must be determined. Based on the type of Access Device and/or on the configuration of the Portal Server, a request may be forwarded to the Rendering Container, for example. The term “rendering” as used herein implies the ability to translate the AML-based templates to device-specific markup. The Rendering Container must be able to present the different channels desired based on the Access Device type and/or configuration. The content of the channels themselves can be generated by a provider, which can include content from a non-rendering Provider 212 or a Rendering Provider 214. Non-rendering Providers 212 can generate actual content in a device-specific format, but Rendering Provider 214 can generate actual content in AML, or a suitable generic language, format. Further, such AML content can be customized. The providers can give their content to the containers for aggregation. A container, such as Rendering Container 210 can include information or copies of content from different providers and can present an integrated view of a document in AML format. A post-processing step may be used to convert an AML document, which may be in the default AML document or in a customized markup, into a device-specific markup document. Such post-processing can occur when Rendering Container 210 calls Rendering Engine 216, which can convert the document into whatever markup is needed for presentation to Access Device 202. For a document received in AML compatible format, Rendering Engine 216 can translate the document based on the type of Access Device 202. Thus, different markups can be sent back from Rendering Engine 216. For example, if the Access Device is a Nokia phone, WML can be sent back from Rendering Engine 216. The type of Access Device can be distinguished and the Rendering Engine can return the appropriate markup. The post-processed content can then go back to the Rendering Container 210 and out to the Access Device 202. Further, the AML can be customized, as will be discussed in more detail below.

FilePath 218 can store various possible file paths for a given Access Device. A default file path for devices needing rendering can be “aml.” However, according to an embodiment, AML can be customized by changing a file path from the default to a path containing customized templates. One example of such a file path for a Nokia 7110 mobile phone can be:
aml/wml/Nokia/7110
   Similarly, an example of such a file path for a Nokia 9110 mobile phone can be:
aml/wml/Nokia/9110

In another method option, device-specific markup can be used for customization. According to embodiments, special AMLContainer “tags” can be included around device-specific markup. In this way, the Rendering Engine will know not to convert or translate the device-specific markup language within the AMLContainer. As an example, three templates may be used in a rendering component in the following fashion:

<Template A begin>

<Template B/>
<Template C/>

<Template A end>

In this case, Templates B and C can be device-specific markup while Template A can include an AMLContainer tag. Accordingly, the Rendering Engine can convert Template A, but not Templates B or C, to a device-specific markup.

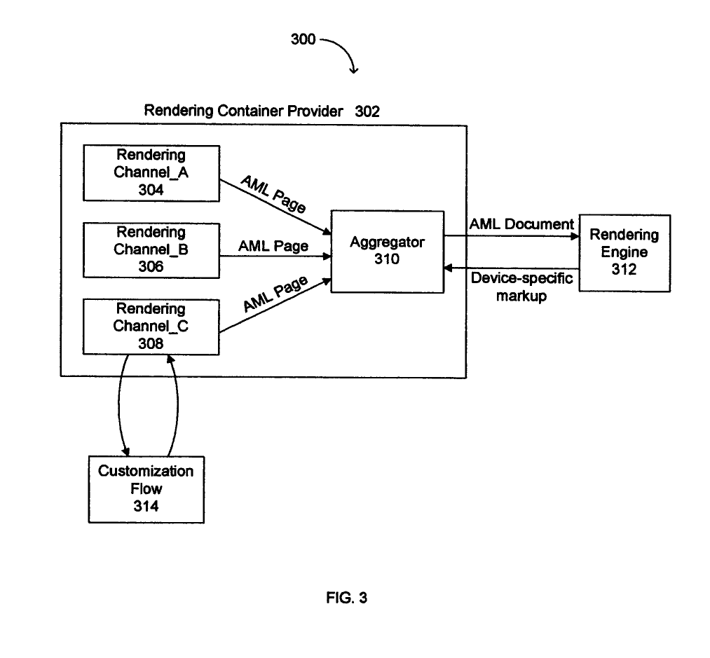

Depending on the type of Access Device and/or the configuration of the Portal Server, channels of content can come from device-specific or “non-rendering” providers and/or via the Rendering Provider path. Both Device-specific Containers 208 and Rendering Container 210 can accommodate a mix of “rendering” and “non-rendering” channels. Further, customization can be performed on rendering channels. Such arrangements will be described in more detail below with reference to FIG. 2 along with FIGS. 3-5.

The flexibility in allowing combinations of channels from non-rendering Providers 212 as well as from Rendering Provider 214 is one advantage of this approach. A particular configuration may designate the device-specific path for optimized performance in cases where certain types of Access Devices are known. For example, a commonly used Nokia type of mobile phone can be supported by a configuration whereby its content is generated by a non-rendering provider via a Device-specific Container 208. Because no post-processing step is needed for this example, there is less translation involved and the access path can be optimized for performance. Also, because Nokia contains a large market share, it may be considered worth the effort to develop Nokia-specific containers. However, this would not necessarily be the case for newer types of PDAs where the market is not yet developed. For these cases, a rendering approach from an AML type document or a customized AML document may be preferred because only the rendering or “back-end” would need to be changed to accommodate a device in this category. Further, because there is currently an installed portal base with many customers, there already are many Device-specific Containers available. Accordingly, the ability to integrate the Rendering Provider 214 information with Device-specific Containers 208 through Rendering Container 210 can be important. In such an approach, the aggregated document can then be fully or partially translated via Rendering Engine 216.

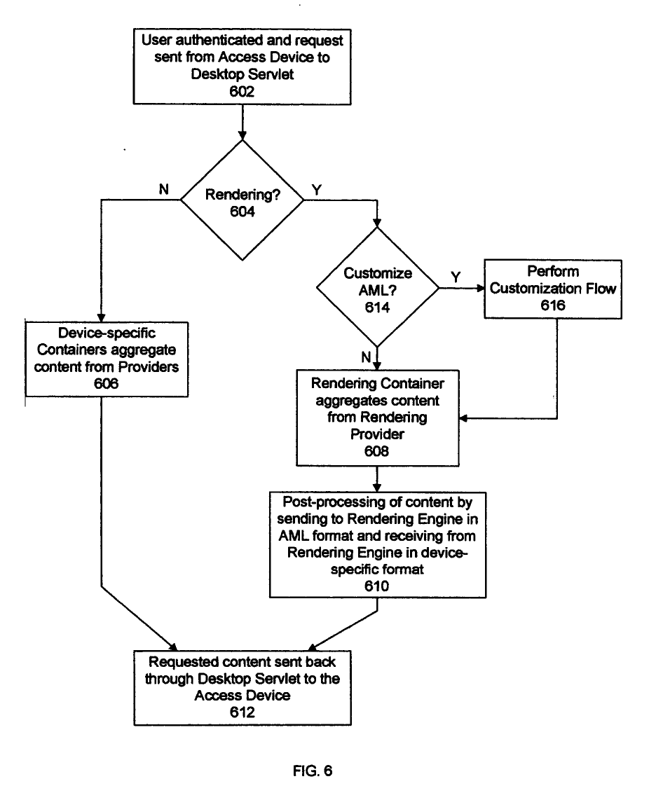

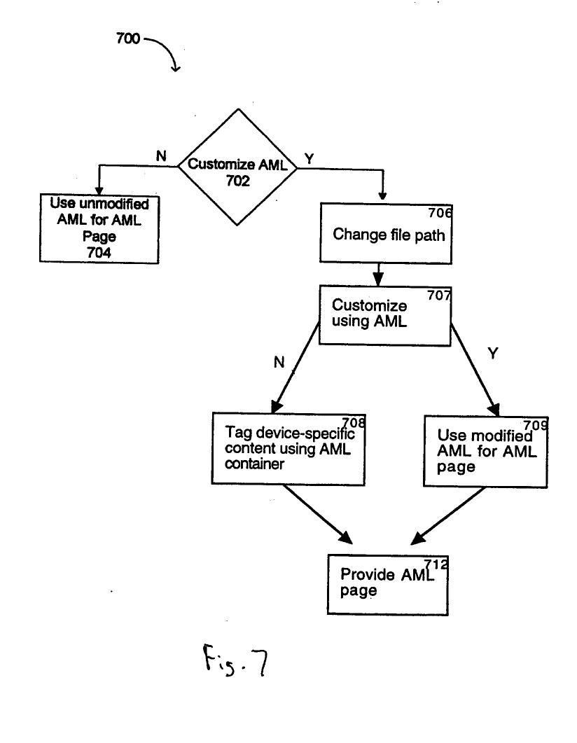

Referring now to FIG. 3, a block diagram of an example rendering container provider having customizable markup capability for all rendering type channels according to an embodiment is shown and indicated by the general reference character 300. This diagram represents the Rendering Provider and Rendering Container interaction as Rendering Container Provider 302 and the associated interaction with Rendering Engine 312. In this example, Rendering Channel_A 304, Rendering Channel_B 306, and Rendering Channel_C 308 all can send information in AML format (“AML Page”) to Aggregator 310. The Aggregator can send the AML Document to Rendering Engine 312 for conversion into Device-specific markup. This example corresponds to a full (i.e., not mixed) rendering path including Rendering Container 210, Rendering Provider 214, and Rendering Engine 216, of FIG. 2. Further, Customization Flow 314 is shown as coupled to Rendering Channel_C 308, but it can be coupled to any of the Rendering Channels for customization of the markup for an “AML Page.” The Customization Flow will be described in more detail below with reference to FIGS. 6 and 7.

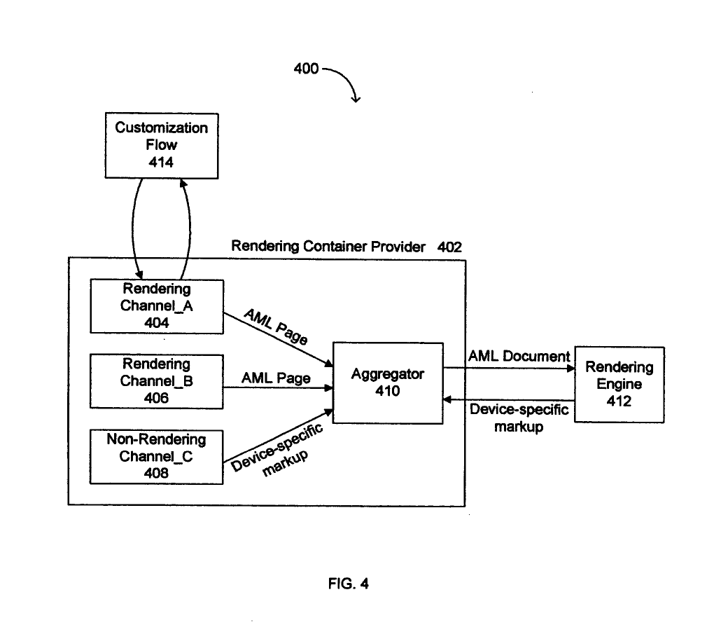

Referring now to FIG. 4, a block diagram of an example rendering container provider having customizable markup capability for two rendering type channels and one non-rendering type channel according to an embodiment is shown and indicated by the general reference character 400. This diagram represents the Rendering Provider, non-rendering Provider, and Rendering Container interaction as Rendering Container Provider 402 and the associated interaction with Rendering Engine 412. In this example, Rendering Channel_A 404 and Rendering Channel_B 406 can send information in AML format (“AML Page”) to Aggregator 410. However, Non-Rendering Channel_C 408 can send information in Device-specific markup to Aggregator 410. The Aggregator can then send an aggregated AML Document to Rendering Engine 412 for conversion into Device-specific markup. This example corresponds to a mixed rendering/non-rendering path aggregated by Rendering Container 210 of FIG. 2. This example path includes Providers 212, Rendering Provider 214, Rendering Container 210, and Rendering Engine 216, of FIG. 2. Further, Customization Flow 414 is shown as coupled to Rendering Channel_A 404, but it can be coupled to any of the Rendering Channels for customization of the markup for an “AML Page.” The Customization Flow will be described in more detail below with reference to FIGS. 6 and 7.

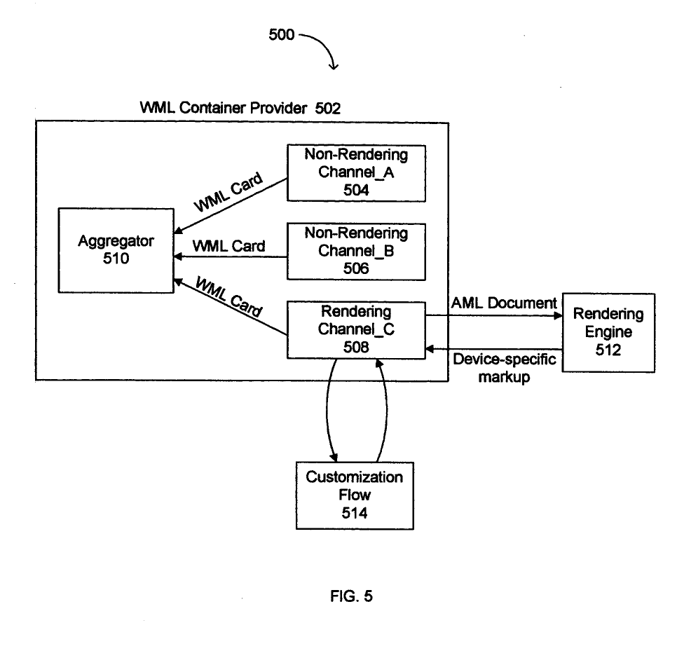

Referring now to FIG. 5, a block diagram of an example WML container provider having customizable markup capability for two non-rendering type channels and one rendering type channel according to an embodiment is shown and indicated by the general reference character 500. In this example, the aggregation is done in a Device-specific Container where the device uses WML. This diagram represents the Rendering Provider, non-rendering Provider, and Device-specific Container (e.g., Nokia) interaction as WML Container Provider 502 and the associated interaction with Rendering Engine 512. In this example, device-specific channels, Non-Rendering Channel_A 504 and Non-Rendering Channel_B 506, can send information in WML format (“WML Card”) as its non-rendering format to Aggregator 510. However, Rendering Channel_C 508 must first have its information converted from AML to WML format. This is done by sending “AML Document” to Rendering Engine 512 for conversion into Device-specific markup, which is WML in this particular example. Rendering Channel_C 508 can then sent its WML Card to Aggregator 510. This example corresponds to a mixed rendering/non-rendering path aggregated by one of the Device-specific Containers 208 of FIG. 2. This example path includes Providers 212, Rendering Provider 214, Device-specific Containers 208, and Rendering Engine 216, of FIG. 2. Further, Customization Flow 514 is shown as coupled to Rendering Channel_C 508 because it is the only Rendering Channel in this example. The Customization Flow can provide for customization of the markup for the “AML Document.” The Customization Flow will be described in more detail below with reference to FIGS. 6 and 7.

FIG. 6 shows a general diagram according to embodiments as a flow diagram of a method of processing a request for content. Step 602 can include user authentication and the sending of a request for content from an Access Device to a Desktop Servlet. A Rendering decision branch 604 can determine, based on the system configuration and/or the type of Access Device, whether rendering is to be performed. If no rendering is to be performed, perhaps because appropriate Device-specific Containers exist in the portal, the Device-specific Containers can aggregate content from non-rendering Providers in step 606. Then, the requested content can be sent back through the Desktop Servlet to the Access Device in step 612. If rendering is to be performed, Customize AML decision branch 614 can be encountered. If the AML is to be customized, Perform Customization Flow step 616 can be done. If the AML is not to be customized or the Perform Customization Flow step 616 is completed, the Rendering Container can aggregate content from the Rendering Provider in step 608. Next, a post-processing step can be performed to convert the content from AML to a device-specific format in step 610. As discussed above, portions of the content may be excluded from conversion if within an AMLContainer as part of one of the customization methods. Then, the requested content can be sent back to the Access Device in step 612. Of course, as discussed above with reference to FIGS. 3-5, various combinations of rendering and/or non-rendering channels can be provided according to embodiments.

Referring now to FIG. 7, a flow diagram of a method of performing customization of markup according to an embodiment is shown and indicated by the general reference character 700. As discussed above, methods of customizing markup according to embodiments include: (i) changing a file path so as to not select the default AML file path; and/or (ii) introducing special “tags” around device-specific markup. In this way, an AML page or document can be changed to customize the generated markup. A Customize AML decision branch 702 can start the flow. If no customization is desired, unmodified AML can be used for the AML Page and/or Document in step 704. If customization is desired, the Change FilePath decision branch 706 can be encountered. In step 706, the file path pointing to the information for the device is changed. In step 707, a decision is made as to whether customized AML will be generated for the device. If yes, in step 709, modified AML is used for the AML page to be provided. If no, in step 708, device specific content is tagged using an AMLContainer. The AML Page and/or Document can be provided in step 712 after customization.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order best to explain the principles of the invention and its practical application, thereby to enable others skilled in the art best to utilize the invention and various embodiments with various modifications as are suited to the particular use contemplated. It is intended that the scope of the invention be defined by the Claims appended hereto and their equivalents.

1. A method for providing customizable client aware content aggregation and rendering in a portal server, comprising:
servicing a request for content using at least one of a plurality of channels;
accessing a first file path to service the request, the first file path pointing to generic non-customized information for a client device;
accessing a second of file path to service the request, the second file path pointing to customized information for the client device, wherein the second file path is accessed subsequent to the first file path;
processing aggregated content from a plurality channels using a rendering engine, the rendering engine configured to output the aggregated content in a markup language tailored for the client device; and
outputting the aggregated content in the second markup language to the client device.

2. The method of claim 1 wherein the generic non-customized information of the first file path includes generic information for the client device.

3. The method of claim 2 wherein the device specific information includes a customizable device specific template

4. The method of claim 1 wherein the first file path is a default file path and the second file path is an optional file path.

5. The method of claim 4 wherein the second file path points to device specific markup language customization for the client device.

6. The method of claim 5 wherein the generic markup language is AML (abstract markup language).

7. A method of customizing a generic markup language, comprising:
as a first option, changing from a default file path to a customized directory file path; and
as a second option, tagging first content using a first container.

8. The method according to claim 7, wherein the default file path includes the generic markup language.

9. The method according to claim 7, wherein the customized directory file path includes a customized device specific markup template.

10. The method according to claim 7, wherein the first content includes a device-specific template.

11. The method according to claim 7, wherein the first container includes a generic markup language template.

12. The method according to claim 7, wherein the generic markup language includes abstract markup language (AML).

13. The method according to claim 10, wherein the tagging prevents a translation of the device-specific template.

14. A computer system configured to execute software to process a customizing of a generic markup language, comprising:
as a first option, changing from a default file path to a customized directory file path; and
as a second option, tagging first content using a first container.

15. The computer system according to claim 14, wherein the default file path includes the generic markup language.

16. The computer system according to claim 14, wherein the customized directory file path includes a customized template.

17. The computer system according to claim 14, wherein the first content includes a device-specific template.

18. The computer system according to claim 14, wherein the first container includes a generic markup language template.

19. The computer system according to claim 14, wherein the generic markup language includes abstract markup language (AML).

20. The computer system according to claim 17, wherein the tagging prevents a translation of the device-specific template.

21. A machine readable medium having embodied thereon a computer program for processing by a machine, the computer program comprising:
code for a customizing of a generic markup language, comprising:
as a first option, changing from a default file path to a customized directory file path; and
as a second option, tagging first content using a first container.

22. The machine readable medium according to claim 21, wherein the default file path includes the generic markup language.

23. The machine readable medium according to claim 21, wherein the customized directory file path includes a customized template.

24. The machine readable medium according to claim 21, wherein the first content includes a device-specific template.

25. The machine readable medium according to claim 21, wherein the first container includes a generic markup language template.

26. The machine readable medium according to claim 21, wherein the generic markup language includes abstract markup language (AML).

27. The machine readable medium according to claim 21, wherein the tagging prevents a translation of the device-specific template.
